(19) United States
(12) Patent Application Publication
(10) Pub. No.: US 2023/0053158 A1
(43) Pub. Date: Feb. 16, 2023

(54) AVIONICS-FREE GLOBAL AVIATION SURVEILLANCE SYSTEMS AND PROCESSES

(71) Applicant: Nexteon Technologies, Inc., Maple Glen, PA (US)

(72) Inventor: Cornelius George Hunter, Cameron Park, CA (US)

(21) Appl. No.: 17/743,803

(22) Filed: May 13, 2022

Related U.S. Application Data
(60) Provisional application No. 63/188,225, filed on May 13, 2021.
(60) Provisional application No. 63/188,500, filed on May 14, 2021.

(51) Int. Cl. G08G 5/00; G05D 1/10; B64C 39/02

(52) U.S. Cl. CPC G08G 5/003; G08G 5/0073; G05D 1/101; B64C 39/024; B64C 2201/122

(57) ABSTRACT

A system for exploiting a transmitted signal from an aircraft or drone to determine parameters of the aircraft or drone's motion. The system includes at least one antenna for receiving the transmitted signal from the aircraft, and an analysis system for analyzing the transmitted signal as compared with stored characteristic anomalies associated with any of the aircraft or drone, and the at least one antenna, for confirming parameters of the aircraft or drone's motion.

### PRIORITY

The present application claims priority to each of the U.S. Provisional Patent Application Ser. No. 63/188,225, filed May 13, 2021, and U.S. Provisional Patent Application Ser. 63/188,500, filed May 14, 2021, the disclosures of each of which are hereby incorporated by reference in their entireties.

### BACKGROUND

In large-scale commercial airspace systems, such as the National Airspace System (NAS) in the United States and other analogous systems around the world, Airspace Navigation Service Providers (ANSPs) rely on surveillance systems to perform Air Traffic Control (ATC) and Air Traffic Management (ATM). Such surveillance systems must meet two overarching requirements: security and accuracy. Surveillance systems must be robust and secure against physical and cyber-attacks, and they must track aircraft with sufficient accuracy to support current and future ATC and ATM procedures. These security and accuracy requirements are becoming increasingly stringent, in part, due to the fact that increasing usage and scope of remote tracking systems may increase potential security threats such as by hacking or cyber-attacks.

Traditionally ANSP surveillance has been primarily performed by ground-based radar systems. Such systems typically are physically protected and transmit their tracking measurements in private, isolated data networks. As such, these systems have the highest level of both physical and cyber security. But these systems typically use technology dating to the mid twentieth century, with tracking accuracies that were sufficient for that earlier era, but are not in the twenty-first century era of precision ATC and environmental awareness.

A more recent surveillance technology, designed in the late twentieth century, is Automatic Dependent Surveillance-Broadcast (ADS-B), which was mandated for use by commercial transport aircraft by the year 2020. As the name suggests, ADS-B provides a surveillance message that is automatically broadcasted by the aircraft (the broadcasted message is known as ADS-B out). The use of ADS-B was different than prior systems that used traditional aircraft transponders that typically transmit a surveillance signal only when interrogated by an externally initiated tracking signal (traditionally transmitted by ground-based tracking radars).

The ADS-B system was designed to provide enhanced air traffic surveillance, compared to what is available with traditional ground-based radars. In addition to the automatic broadcast feature, the ADS-B system provides, at a rate of 1 Hz or higher, additional data that include latitude, longitude, ground speed, and vertical speed.

But unlike radar systems, the ADS-B system is vulnerable to cyber-attacks, in part, due to it being well known and commonly used. For example, the ADS-B standard does not support verification of the integrity of the broadcasted navigation messages. In addition to this lack of authentication, ADS-B also lacks encryption, and it is consequently relatively easy to send out false information to spoof aircraft or drone trajectories. Another attack vector is via the Global Positioning System (GPS), which provides ADS-B transmissions with satellite navigation data. In addition to its vulnerability to cyber-attacks, the ADS-B system is susceptible to non-malicious degradation such as operator nonconformance and system failures. One major example would be GPS maintenance and failures.

These vulnerabilities of the ADS-B system compromise its fitness for use in safety critical applications such as ATC. There remains a need therefore, for more efficient and economical yet secure systems for providing surveillance of aircraft and drones.

### SUMMARY

In accordance with an aspect, the invention provides a system for exploiting a transmitted signal from an aircraft or drone to determine parameters of the aircraft or drone's motion. The system includes at least one antenna for receiving the transmitted signal from the aircraft, and an analysis system for analyzing the transmitted signal as compared with stored characteristic anomalies associated with any of the aircraft or drone, and the at least one antenna, for confirming parameters of the aircraft or drone's motion.

In accordance with another aspect, the invention provides a method of exploiting a transmitted signal from an aircraft or drone to determine parameters of the aircraft or drone's motion. The method includes receiving the transmitted signal from the aircraft or drone by at least one antenna, analyzing the transmitted signal as compared with stored characteristic anomalies associated with any of the aircraft or drone, and the at least one antenna, and confirming parameters of the aircraft or drone's motion.

### BRIEF DESCRIPTIONS OF THE DRAWINGS

The following may be further understood with reference to the accompanying drawings in which:

FIG. 1 shows an illustrative diagrammatic view of a data transmission system in accordance with an aspect of the present invention;

FIG. 2 shows an illustrative diagrammatic view of a motion parameter determination system in accordance with an aspect of the present invention;

FIG. 3 shows an illustrative diagrammatic view of a data storage and retrieval system in accordance with a system in accordance with an aspect of the present invention;

FIG. 4 shows an illustrative diagrammatic view of a system in accordance with an aspect of the present invention in which anomalies in transmission data from an aircraft or drone produce a noisy signal;

FIG. 5 shows an illustrative diagrammatic view of the system of FIG. 4 in which transmission data from above and below an aircraft or drone produce distinct signals;

FIG. 6 shows an illustrative diagrammatic view of the system of FIG. 4, showing signal radiation from the aircraft received at a ground-based platform;

FIG. 7 shows an illustrative diagrammatic view of the system of FIG. 4, showing signal radiation from the aircraft received at a plurality of ground-based platforms; and

FIG. 8 shows an illustrative diagrammatic view of the system of FIG. 4, with signal radiation from the aircraft received at a ground-based platform showing aircraft transponder notional temporal patterns in the transmission.

The drawings are shown for illustrative purposes only.

### DETAILED DESCRIPTION

In accordance with various embodiments, the invention provides systems and methods that both (i) safeguard the ADS-B system against malicious and non-malicious attacks and (ii) maintain and improve its surveillance accuracy. An independent surveillance system for robustness and security is provided as follows. ADS-B is a dependent surveillance system, meaning that the ATC tracking data are dependent on the integrity of the navigation data encoded onto the aircraft transmitted signal. In addition to the encoded information however, ADS-B also provides a signal-rich environment, enabling a system to produce a fully independent surveillance system. Specifically, whereas the ADS-B surveillance system was designed only to use the navigational data encoded onto the ADS-B out message, the system also uses the physical characteristics of the transponder signal, as described below.

Existing surveillance technologies and systems that use the physical characteristics of the aircraft transponder signal use the multi-lateration (MLAT) technique. MLAT is based on the difference of the time of arrival of the ADS-B out signal, as measured by different collection platforms. A collection platform includes an antenna, receiver, electronics for signal processing, and communication equipment to transmit the observed signal data to a central processing facility. At the central processing facility the signal data received from different collection platforms are compared, and the various time of arrival measurements are subtracted to determine the differential time of arrival, known as TDOA (time difference of arrival).

The MLAT technique however, suffers from inadequate accuracy, which is caused by several deficiencies. The first problem is a lack of observers. A minimum of three TDOA measurements is required to compute the three-dimensional (3D) position of the aircraft (e.g., latitude, longitude, and altitude). Since n+1 collection platforms are required to compute n TDOA measurements, this means that a minimum of four collection platforms are required to compute the 3D aircraft position. Existing surveillance systems, such as the Ariane space-based ADS-B surveillance system, which conforms to the Iridium constellation of spacecraft, often lack a sufficient number of collection platforms to compute the 3D aircraft position consistently.

The number of collection platforms however, is only one facet of the problem. Even if four collection platforms are within view of an aircraft target, one or more of the collection platforms may fail to detect and receive the ADS-B signal successfully, for example, due to a low signal-to-noise (SNR) ratio at the antenna. Low SNR can be due to multiple causes specific to each collection platform, such as range to the aircraft, position of the collection platform relative to the aircraft target, terrain, obstacles, multipath, etc. A system is provided herein in accordance with an aspect of the invention that solves this first problem with two innovations. It incorporates a large-scale network of collection platforms specifically designed for proper coverage, and it uses a high gain (at least 20 dBi) antenna at the collection platform, again designed specifically for sufficient SNR.

A second problem is that existing surveillance systems fail to provide a sufficient update rate of TDOA observations. In other words, even when producing four or more TDOA observations, the number of TDOA observations per unit time is relatively low. The lack of updates causes the tracking filter to lag the aircraft maneuvers, and otherwise produce tracking data with relatively large uncertainty. This failure to produce a sufficient update rate of TDOA observations is due to several causes, including all of the inadequacies mentioned above in the first problem, as well as a limited data throughput of the collection platform electronics, and exclusive use of the ADS-B out signal. The systems disclosed herein solve this problem with additional receiver platforms as described above, combined with high-throughput collection platform purpose-designed electronics, and the exploitation of all signals transmitted by the aircraft transponder, including the Traffic Collision Avoidance System (TCAS), Mode-S, Mode-A, and Mode-C signals. By using these signals, in addition to the ADS-B out signal, the TDOA data rate is increased by more than an order of magnitude, substantially reducing the aircraft tracking uncertainty because such uncertainty is proportional to the inverse square root of the number of measurements used to compute the aircraft track.

A third problem is that existing surveillance systems suffer from a lack of geometric diversity in their measurements. The MLAT technique requires geometric diversity of the collection platforms relative to the aircraft target and a lack thereof causes an increased uncertainty in the computed aircraft track. This effect is expressed in a parameter known as the geometric dilution of precision (GDOP). The systems disclosed herein solve this problem with a network of collection platforms that is distributed across both ground and space segments. Existing surveillance systems are either on the ground, or in space in accordance with an aspect of the invention. The innovative combination of these two domains provides aircraft track computations with much greater geometric variation, and therefore with a greatly improved GDOP.

A fourth problem is that existing MLAT systems suffer from high uncertainty in their aircraft track computations because TDOA provides position information only. Accurate aircraft tracking requires an accurate estimate of the aircraft velocity, as well as its position. In MLAT systems, the aircraft velocity must be derived by taking the derivative of the position data, and the derivative computation is an inherently noisy operation. This high noise is exacerbated even more by the various sources of MLAT tracking uncertainty discussed above in the first three problems. The system solves this problem in accordance with an aspect of the invention, by using the difference in frequency of arrival at each collection platform. These data are known as FDOA (frequency difference of arrival) and are commonly referred to as “Doppler” data. Whereas TDOA provides position information, FDOA provides velocity information. As FDOA is already at the velocity level, the derivative is not taken. Therefore, the Doppler shift of an aircraft ADS-B transmission, measured accurately from multiple, geographically-distributed collection platforms, enables the reconstruction of the aircraft 3D velocity vector. This information enables several new services, including: 1) aircraft or drone flight surveillance, independent of aircraft or drone navigation systems or GPS position and navigation data, 2) Meteorology data, and 3) independent information to verify the authenticity of the signal information, thus enhancing Cyber security. See Matthias Schafer, et. al., “Secure Motion Verification using the Doppler Effect,” Proceedings of the 9th ACM Conference on Security & Privacy in Wireless and Mobile Networks, pp. 135-145, Darmstadt, Germany, Jul. 18-20, 2016, and N. Ghose, L. Lazos, “Verifying ADS-B Navigation Information Through Doppler Shift Measurements,” IEEE/AIAA 34th Digital Avionics Systems Conference (DASC), September 2015.

For flight surveillance and meteorology data, the state of the art has not identified the extraction and use of ADS-B Doppler data, much less data combined from multiple collection platforms. With regard to independent verification information, while some researchers have identified ADS-B Doppler data for use in cyber security, they have only envisioned single or dual collection platforms. The systems herein disclosed employ a minimum of four simultaneous collection platforms, thus enabling a full 3D estimation of the aircraft position and velocity in accordance with an aspect of the invention.

The TDOA and FDOA data are based on time of arrival (TOA) and frequency of arrival (FOA) measurements, respectively. For non-relativistic problems such as this, the frequency of arrival at the collection platform is:

$$FOA = ( 1 + \frac{Δ v}{c} ) {f}_{0} \qquad ( 1 )$$

and the Doppler shift, Δf, is:

$$Δ f ≡ FOA - {f}_{0} = \frac{Δ v}{c} {f}_{0} \qquad ( 2 )$$

where c is the speed of light (˜300×10⁶ m/s), Δv is the relative velocity, or range-rate, between receiver and source, f₀ is the emitted ADS-B frequency (approximately 1090 MHz) at the source, and Δf is the FOA at the collection platform minus the source frequency, f₀. Rearranging, we have:

$$Δ v = \frac{c Δ f}{{f}_{0}} \qquad ( 3 )$$

In a method of an aspect of the invention, the FOA and TOA measurement signals may be used from each collection platform, independently (rather than deriving the FDOA and TDOA data). In this approach, the aircraft transponder transmission frequency, and time of transmission, must be estimated along with the aircraft position and velocity. There are several advantages to this. One advantage is that the extra computational step of computing multiple FDOAs and TDOAs, is now unnecessary. A second advantage is that the transponder transmit frequency does not randomly change between consecutive transmissions, but rather tends to change gradually, and can be described as a first- or second-order polynomial, as a function of time. This means that when an aircraft is being tracked, in addition to its position and velocity, its transponder transmit frequency can be predicted with reasonable accuracy over short periods of time. Given such an estimate of the transponder transmit frequency, merely three different FOA measurements are required (compared to the four FOA measurements required when using FDOA) to estimate the three-dimensional aircraft velocity vector. Of course, GDOP concerns apply, but no more so than in the FDOA case, as discussed above.

A third advantage is that whereas in the FDOA and TDOA case a minimum of two FOA and two TOA measurements are required in order to perform a trajectory update, now in the case of FOA and TOA, merely a single FOA and a single TOA measurement are required.

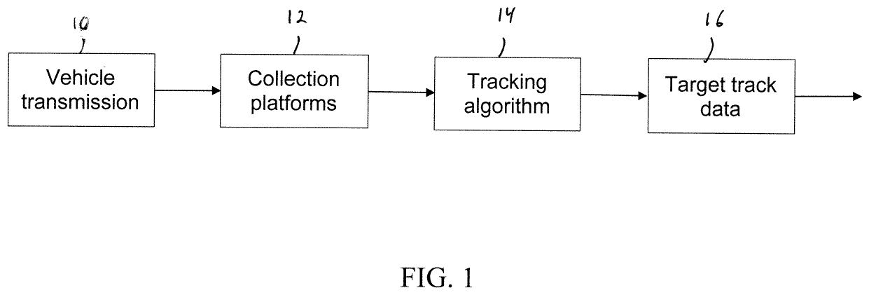

FIG. 1 shows the ADS-B collection data flow sequence in the case of using TOA and FOA sensor measurements, rather than TDOA and FDOA. As shown in FIG. 1, a vehicle (aircraft or drone) provides transmission 10 in the form of a transponder signal that propagates to the collection platforms 12. After collecting and processing the transponder signal, each collection platform transmits its TOA and FOA measurements to the tracking algorithm 14, located at the central data processing facility. In this case, merely three collection platforms are required to estimate the three-dimensional aircraft velocity vector, and even only a single collection platform, producing only a single FOA and single TOA measurements, can be used. The tracking algorithm now has a total of eight state variables: three positions (e.g., x-position, y-position, z-position), three velocities (e.g., x-velocity, y-velocity, z-velocity), the transponder transmission time, and the transponder transmission frequency. The tracking algorithm 14 sends its new, updated, aircraft or drone state vector (containing all eight state variables) to be stored in a target track database. Target track data 16 are then exported to users. This method of using the FOA and TOA measurements, rather than the FDOA and TDOA measurements, provides several advantages as discussed above.

Finally, a fifth problem is that existing surveillance systems are reliant on GPS data in their collection platform electronics. Specifically, they use GPS data to provide an accurate clock, which is required to compute the time of arrival (and frequency of arrival) measurements. The fact that existing surveillance systems are reliant on GPS makes them vulnerable to GPS outages, degradations, failures, and so forth. The system of an aspect of the invention solves this problem by employing a chip-scale atomic clock (CSAC). In this design, the CSAC is integrated with the GPS clock, such that the CSAC is continually calibrated by the GPS clock when the GPS clock is validated. When the GPS clock fails or degrades, the CSAC is then used. This approach ensures that the CSAC is fully calibrated, if and when it is needed.

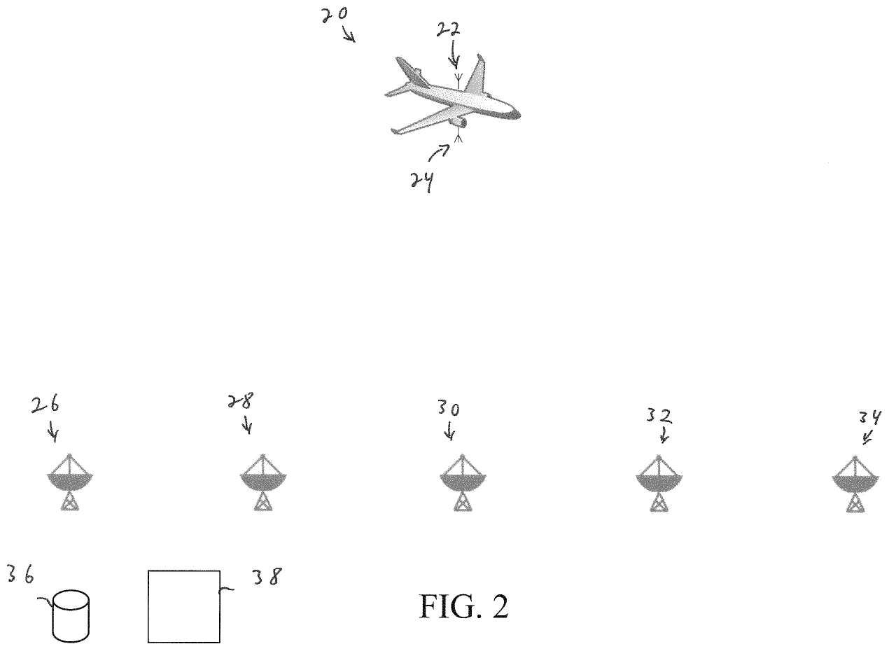

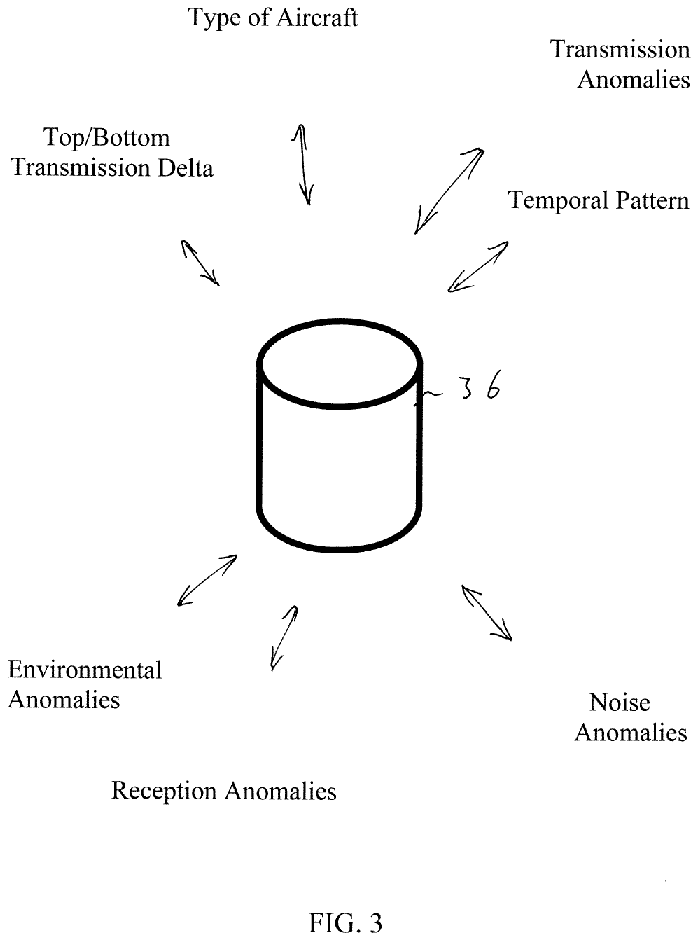

FIG. 2 shows a system that includes an aircraft or drone 20 with antennas above and below antennas the aircraft or drone as shown at 22 and 24. One or more reception platforms (antennas) 26, 28, 30, 32, 34 etc. are provided, and are coupled to one or more computer processing systems 38. The processing system 38 is also in communication with one or more data storage systems 36, and with reference to FIG. 3, the data storage system 36 may include data collected over time regarding any of types of aircraft or drones, differences in reception between top and bottom antennas, transmission anomalies, temporal patterns, as well as environment anomalies, reception anomalies and noise anomalies regarding each antenna. In short, any transmission or reception anomalies specific to each aircraft or drone, or specific to each antenna, may be previously known (through history or teaching) and may be used to verify the authenticity of a transmitted signal.

The systems and methods further provide threat detection, characterization, and ADS-B signal validation as follows. As described above, the independent surveillance system provides a robust, secure, and accurate aircraft tracking capability. It is not vulnerable to degradation, failure, or cyber-attacks in both the ADS-B system and GPS. It is not vulnerable to these threats because it does not use the aircraft navigation data encoded on the ADS-B signal. Instead, it merely uses the physical characteristics of the signal. Therefore, degraded, flawed, erroneous or spoofed navigational data are inconsequential to the independent surveillance system.

In addition to providing this independent surveillance, the system also provides a threat detection, characterization, and ADS-B signal validation service. This is important because while the independent surveillance system is robust to degradation, failure, or cyber-attacks, nonetheless it is of high interest to operators and authorities to be alerted when such events do occur. The system's threat detection, characterization, and signal validation service uses four different categories of exhaustive tests. These tests are performed continually, and in real-time. The four categories are based on, signal strength, temporal domain, frequency domain and 3D trajectory reconstruction.

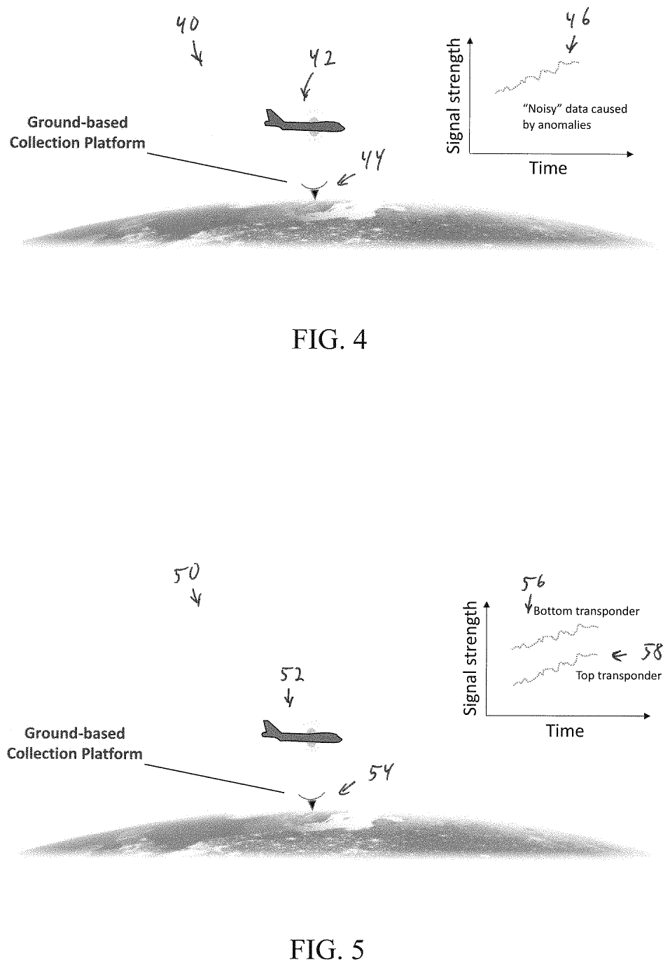

The signal strength test uses the time history of the signal strength measured at each collection platform. FIG. 4, which shows ADS-B notional signal strength data, illustrates this measurement. FIG. 4 shows diagrammatically at 40, signal radiation from an aircraft or drone 42 that may be received by an antenna 44. As FIG. 4 shows at 46, the signal strength data are somewhat noisy. Nonetheless, these data provide valuable information. In many collection scenarios, the antenna receives alternating transmissions from transponders on top and bottom of the aircraft, causing the signal strength data to show two distinct traces, as FIG. 5 illustrates.

In particular, FIG. 5 shows diagrammatically at 50, signal radiation from an aircraft or drone 52 that may be received by an antenna 54. FIG. 5 shows at 56, 58 ADS-B notional signal strength data with two traces from transponders on top (shown at 58) and bottom (shown at 56) of aircraft. Using an historical database of past collections, the system derives the behavior of the signal strength data, in terms of this dual-trace characteristic. Using the characteristics of the aircraft trajectory (altitude, geographic position, velocity) and transponder identity, the system predicts this expected behavior. It then compares the predicted behavior with the observed pattern to derive a validation score, the first of many validation scores that will be used to derive an overall, aggregate, validation score, indicating the likelihood that the target is compromised in any way.

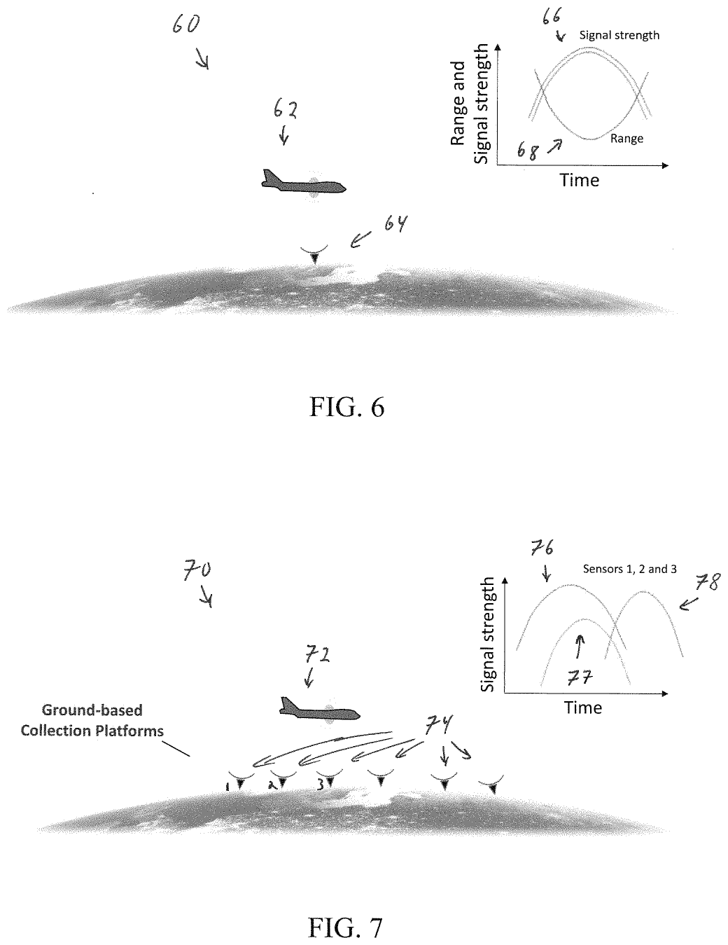

In addition to the dual-trace characteristic, another notable characteristic of the signal strength data is that it is proportional to the inverse square of the target-receive slant range. Therefore, a typical aircraft pass causes a rise and fall in the signal strength as the range decreases and then increases, as FIG. 6 illustrates.

FIG. 6 shows diagrammatically at 60, signal radiation from an aircraft or drone 62 that may be received by an antenna 64. FIG. 6 shows at 66 and 68, ADS-B notional signal strength data increases and decreases (shown at 66) with range (shown at 68) as the aircraft passes through the point of closest approach. The system exploits this characteristic of the signal strength data. Using the 3D trajectory reconstruction for an aircraft, we derive the expected signal strength profile. While the precise magnitude of the signal strength data is not particularly important in this test, the overall shape, and maximum point are important, as they are consistently repeated, and they are difficult to emulate in a cyber-attack. The system again uses a historical database of past collections to derive the overall shape of the signal strength data, in terms of its rise and fall. The system then compares the predicted shape with the observed pattern to derive a second validation score.

This test becomes even more powerful when used across a multiplicity of collection platforms. While the overall shape of the signal strength data at a single collection platform is difficult to emulate in a cyber-attack, it becomes increasingly difficult to emulate at multiple, different, receiver locations, as FIG. 7 illustrates.

FIG. 7 shows diagrammatically at 70, signal radiation from an aircraft or drone 72 that may be received by a plurality of antennas 74 (including, for example, sensors 1, 2, 3 as indicated). FIG. 7 shows ADS-B notional signal strength data increases and decreases at multiple collection platforms as shown at 76 (for sensor 1), 77 (for sensor 2) and 78 (for sensor 3), which depends at least in part, on the arrangement of the sensors as well as the angles of approach of the aircraft or drone. The system again uses a historical database of past collections to derive the overall shape of the signal strength data, in terms of its rise and fall, at all of the collection platforms that receive the signal from the target aircraft. Therefore, this second validation score is repeated across several collection platforms.

In addition to the dual-trace and rise-fall characteristics, another important characteristic of the signal strength data is its fine-grain behavior. This more detailed aspect of the signal strength data may be interpreted as noise by inexperienced operators. But it is due to the particular features of the collection scenario that are specific to the collection platform. These particulars include the position of the collection platform relative to the aircraft target, terrain and obstacles that can influence the signal strength, multipath and interference, and effects in the immediate surroundings of the receiver. These fine-grain details of a particular collection scenario are not publicly known, and thus are difficult to emulate in a cyber-attack. The system again uses a historical database of past collections to derive the fine-grain behavior of the signal strength data for a particular target aircraft. The system then compares the predicted details with the observed pattern to derive yet a third type of validation score.

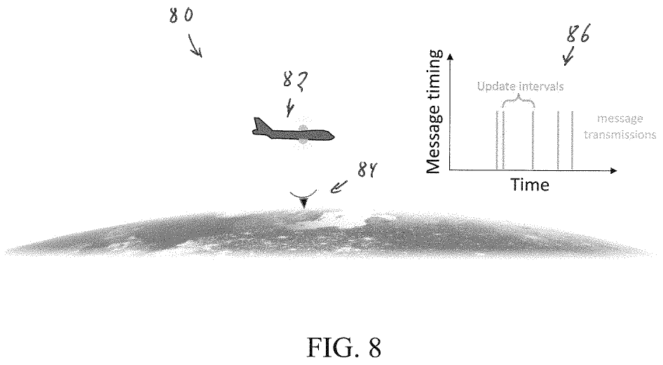

Next the temporal domain test uses the time intervals between transmissions from the transponder of a particular target aircraft. Here we include the Traffic Collision Avoidance System (TCAS), Mode-S, Mode-A, and Mode-C signals, in addition to the ADS-B out signal. Different transponder types, and different operators, tend to have different update intervals, and overall temporal patterns and behaviors, regarding these various signals, as FIG. 8 illustrates.

FIG. 8 shows diagrammatically at 80, signal radiation from an aircraft or drone 82 that may be received by an antenna 84. FIG. 8 shows at 86 aircraft transponder notional temporal pattern in its transmissions. The system again uses a historical database of past collections to derive the predicted temporal behavior for a particular target aircraft. The system then compares the temporal data with the observed pattern to derive yet a fourth type of validation score.

Next the frequency domain test uses the radio frequency (RF) characteristics of a transmission, and its behavior across multiple transmissions, from a given target aircraft. These transmissions are nominally at a frequency of 1090 MHz, but the specifications allow for a relatively wide (1 MHz) band. Therefore, not surprisingly, different transponder types, and different operators, tend to transmit at different base frequencies. Next, transmitters can have significant frequency and phase drift, and individual transponders have relatively unique frequency and phase drift characteristics.

In accordance with various aspects, therefore, the system of the invention may combine any of the above functionalities for further system robustness. The characteristic anomalies may include any and all of signal noise associated with signals transmitted by the aircraft or drone, signal noise associated with the at least one antenna, interference by geological features of transmitted signals received at the at least one antenna, interference by human-made structures of transmitted signals received at the at least one antenna, differences between the above the aircraft or drone component and the below the aircraft or drone component for that aircraft or drone, characteristics of signal strength variation with distance of the at least one antenna, signal components received at a plurality of antennas including the at least one antenna, and wherein the characteristic anomalies include differences between the signal components received at the plurality of antennas.

The system again uses a historical database of past collections to derive the predicted frequency behavior for a particular target aircraft. The system then compares the expected frequency and phase data with the observed pattern to derive yet a fifth type of validation score. The transmitted signal may therefore be an automated dependent surveillance—broadcast (ADS-B) signal, and the stored characteristic anomalies may be provided based on data generated over an extended time period, and/or provides based on machine learning. The at least one antenna may include a ground-based collection platform.

Finally, the 3D trajectory reconstruction test uses the system's estimate of the target aircraft position and velocity histories. In this test the system compares this estimated track data with the navigation data encoded onto the ADS-B out signal. Discrepancies are indicative of degraded or failed avionics or GPS systems, or cyber-attacks. This test provides yet a sixth type of validation score. It is far more powerful than single or double TDOA trace tests that current systems use. The system may therefore compute the aircraft or drone 3D position and velocity vector, and may provide enhanced aircraft or drone position and velocity vector estimation.

The system provides integrated high-accuracy surveillance service in accordance with an aspect. As described above, the system provides the important service of continually, and in real-time, monitoring target aircraft for off-nominal scenarios. Such scenario may include system degradation, failure, or cyber-attack. In off-nominal scenarios the system detects, identifies, and characterizes the nature of the event.

While this service is of high importance, off-nominal scenarios are relatively rare. In most scenarios, aircraft transponder signals are found to be nominal. In such cases, once the system has validated the signal, it can integrate the encoded navigational data with the measurements of the physical characteristics (i.e., the TOA and FOA, or TDOA and FDOA data) to compute an even more accurate aircraft trajectory estimate. In this way, the system computes the most accurate trajectory estimate possible.

Disclosed herein are technologies that both (i) safeguard the ADS-B system against malicious and non-malicious attacks and (ii) maintain and improve its surveillance accuracy. This disclosure remedies the five significant problems that existing MLAT systems suffer. It does this with advanced methods for threat detection, characterization, and ADS-B signal validation. For the common case of validated ADS-B signals, this disclosure presents the innovative method of integrating the high-accuracy time- and frequency-of-arrival measurements with the ADS-B encoded navigational data.

Those skilled in the art will appreciate that numerous modifications and variations may be made to the above disclosed embodiments without departing from the spirit and scope of the present invention.

What is claimed is:

1. A system for exploiting a transmitted signal from an aircraft or drone to determine parameters of the aircraft or drone's motion, said system comprising at least one antenna for receiving the transmitted signal from the aircraft, and an analysis system for analyzing the transmitted signal as compared with stored characteristic anomalies associated with any of the aircraft or drone, and the at least one antenna, for confirming parameters of the aircraft or drone's motion.

2. The system as claimed in claim 1, wherein the transmitted signal is an automated dependent surveillance—broadcast (ADS-B) signal.

3. The system as claimed in claim 1, wherein the characteristic anomalies include signal noise associated with signals transmitted by the aircraft or drone.

4. The system as claimed in claim 1, wherein the characteristic anomalies include signal noise associated with the at least one antenna.

5. The system as claimed in claim 1, wherein the characteristic anomalies include interference by geological features of transmitted signals received at the at least one antenna.

6. The system as claimed in claim 1, wherein the characteristic anomalies include interference by human-made structures of transmitted signals received at the at least one antenna.

7. The system as claimed in claim 1, wherein the transmitted signal includes an above the aircraft or drone signal component and a below the aircraft or drone signal component, and wherein the characteristic anomalies include differences between the above the aircraft or drone component and the below the aircraft or drone component for that aircraft or drone.

8. The system as claimed in claim 1, wherein the characteristic anomalies include characteristics of signal strength variation with distance of the at least one antenna.

9. The system as claimed in claim 1, wherein the characteristic anomalies include signal noise associated with the at least one antenna, interference by geological features of transmitted signals received at the at least one antenna, and interference by human-made structures of transmitted signals received at the at least one antenna.

10. The system as claimed in claim 1, wherein the transmitted signal includes signal components received at a plurality of antennas including the at least one antenna, and wherein the characteristic anomalies include differences between the signal components received at the plurality of antennas.

11. The system as claimed in claim 1, wherein the transmitted signal includes signal components received at the at least one antenna, and wherein the characteristic anomalies include time differences between the signal components received at the at least one antenna.

12. The system as claimed in claim 1, wherein the stored characteristic anomalies are provided based on data generated over an extended time period.

13. The system as claimed in claim 1, wherein the stored characteristic anomalies are provided based on machine learning.

14. The system as claimed in claim 1, wherein the at least one antenna includes a ground-based collection platform.

15. The system as claimed in claim 1, wherein the system computes the aircraft or drone 3D position and velocity vector.

16. The system as claimed in claim 1, wherein the system provides enhanced aircraft or drone position and velocity vector estimation.

17. A method of exploiting a transmitted signal from an aircraft or drone to determine parameters of the aircraft or drone's motion, said method comprising receiving the transmitted signal from the aircraft or drone by at least one antenna, analyzing the transmitted signal as compared with stored characteristic anomalies associated with any of the aircraft or drone, and the at least one antenna, and confirming parameters of the aircraft or drone's motion.

18. The method as claimed in claim 17, wherein the transmitted signal is an automated dependent surveillance—broadcast (ADS-B) signal.

19. The method as claimed in claim 17, wherein the characteristic anomalies include signal noise associated with signals transmitted by the aircraft or drone.

20. The method as claimed in claim 17, wherein the characteristic anomalies include signal noise associated with the at least one antenna.

21. The method as claimed in claim 17, wherein the characteristic anomalies include interference by geological features of transmitted signals received at the at least one antenna.

22. The method as claimed in claim 17, wherein the characteristic anomalies include interference by human-made structures of transmitted signals received at the at least one antenna.

23. The method as claimed in claim 17, wherein the transmitted signal includes an above the aircraft or drone signal component and a below the aircraft or drone signal component, and wherein the characteristic anomalies include differences between the above the aircraft or drone component and the below the aircraft or drone component for that aircraft or drone.

24. The method as claimed in claim 17, wherein the characteristic anomalies include characteristics of signal strength variation with distance of the at least one antenna.

25. The method as claimed in claim 17, wherein the transmitted signal includes signal components received at a plurality of antennas including the at least one antenna, and wherein the characteristic anomalies include differences between the signal components received at the plurality of antennas.

26. The method as claimed in claim 17, wherein the characteristic anomalies include signal noise associated with the at least one antenna, interference by geological features of transmitted signals received at the at least one antenna, and interference by human-made structures of transmitted signals received at the at least one antenna.

27. The method as claimed in claim 17, wherein the transmitted signal includes signal components received at the at least one antenna, and wherein the characteristic anomalies include time differences between the signal components received at the at least one antenna.

28. The method as claimed in claim 17, wherein the stored characteristic anomalies are provided based on data generated over an extended time period.

29. The method as claimed in claim 17, wherein the stored characteristic anomalies are provided based on machine learning.

30. The method as claimed in claim 17, wherein the at least one antenna includes a ground-based collection platform.

31. The method as claimed in claim 17, wherein the method computes the aircraft or drone 3D position and velocity vector.

32. The method as claimed in claim 17, wherein the method provides enhanced aircraft or drone position and velocity vector estimation.

33. The method as claimed in claim 17, wherein the method includes verifying that the transmitted signal is an authentic signal from the aircraft or drone.
